(19) United States
(12) Patent Application Publication
(10) Pub. No.: US 2008/0203019 A1
(43) Pub. Date: Aug. 28, 2008

(54) MEMBRANE BATCH FILTRATION PROCESS

(76) Inventors: Nicholas William Harcsar Adams, Hamilton (CA); Manwinder Singh, Burlington (CA); Kevin Simon Joseph Dufresne, Dundas (CA); Pierre Lucien Cote, Dundas (CA)

Correspondence Address: BERESKIN AND PARR, 40 KING STREET WEST, BOX 401, TORONTO, ON, M5H 3Y2, CA

(21) Appl. No.: 12/120,102

(22) Filed: May 13, 2008

Related U.S. Application Data
(63) Continuation of application No. 11/061,629, filed on Feb. 22, 2005.
(60) Provisional application No. 60/547,787, filed on Feb. 27, 2004.
(60) Provisional application No. 60/575,804, filed on Jun. 2, 2004.

(51) Int. Cl. B01D 65/02; B01D 21/30

(52) U.S. Cl. 210/636; 210/739; 210/136

(57) ABSTRACT

A membrane batch filtration process has a step of reducing the water level in the tank by permeation prior to emptying the tank to reduce the volume of water drained after each batch. Permeation may continue even after a portion of the membranes is exposed to air to further lower the water level. The membranes may be backwashed after the water level has been lowered. The water level may be lowered again after the backwash. The tank drain may begin with a portion of the membranes exposed to air.

This application is a continuation of U.S. application Ser. No. 11/061,629, filed Feb. 22, 2005, which claims benefit of U.S. application Ser. No. 60/547,787 filed Feb. 27, 2004, and U.S. application Ser. No. 60/575,804 filed Jun. 2, 2004 all of which are incorporated herein, in their entirety, by this reference to them.

### FIELD OF THE INVENTION

This invention relates to membrane separation devices and processes as in, for example, water filtration using membranes.

### BACKGROUND OF THE INVENTION

A batch filtration process has a repeated cycle of concentration, or permeation, and deconcentration steps. During the concentration step, permeate is withdrawn from a fresh batch of feed water initially having a low concentration of solids. As the permeate is withdrawn, fresh water is introduced to replace the water withdrawn as permeate. During this step, which may last from 10 minutes to 4 hours, solids are rejected by the membranes and do not flow out of the tank with the permeate. As a result, the concentration of solids in the tank increases, for example to between 2 and 100, more typically 5 to 50, times the initial concentration. The process then proceeds to the deconcentration step. In the deconcentration step, which is typically between 1/50 and 1/5 the duration of the concentration step, a large quantity of solids are rapidly removed from the tank to return the solids concentration back to the initial concentration. This may be done by draining the tank and refilling it with new feed water. To help move solids away from the membranes themselves, air scouring and backwashing are often used before or during the deconcentration step. This type of process was initially practiced only in small or pressurized systems, but has since been used in large open tank systems such as the ones described below.

International Publication No. WO98/28066 describes a membrane filtration module having vertical hollow fiber membranes between a pair of circular headers. Scouring air is provided through holes in the bottom header. Permeate is withdrawn from the top header. In a batch process, a tank holding the module is drained periodically and re-filled with new feed water.

U.S. Pat. No. 6,303,035 describes a module of horizontal hollow fiber membranes used in a batch process. Scouring air is provided by an aerator below the module and the tank is drained and re-filled between batches.

U.S. Pat. No. 6,375,848 describes a batch process using a module of hollow fiber membranes. A tank holding the membranes is deconcentrated between batches by opening a drain while simultaneously increasing the rate of feed flow such that the membranes remain under water during the deconcentration.

International Publication No. WO01/36075 describes modules of membranes arranged to substantially cover the cross-sectional area of a tank. In a batch process, the tank is deconcentrated by flowing water upwards through the modules and out through an overflow at the top of the tank.

### SUMMARY OF THE INVENTION

It is an object of the invention to provide an apparatus and method for treating water. It is another object of the invention to provide a membrane separation device and process. The following summary is intended to introduce the reader to the invention and not to define the invention, which may reside in a sub-combination of the following features or in a combination involving features described in other parts of this document.

In one aspect, this invention relates to a method for backwashing immersed membranes that reduces the volume of water discharged per backwash or deconcentration. For immersed membrane systems operated in a batch mode, where water is discharged periodically by draining the membrane tank, there is a relationship between filtration cycle time and backwash volume.

$${t}_{F} = {V}_{BW} \times \frac{R}{{Q}_{F} ( 1 - R )}$$

### Where:

t_{F}=Filtration cycle time
V_{BW}=Volume of discharged water
Q_{F}=Filtration flow rate
R=Recovery (Filtrate/Feed)

By minimizing the volume of discharged water, the filtration cycle time can be reduced while maintaining the same system recovery. A shorter filtration cycle time leads to improved membrane performance by reducing membrane fouling and therefore allowing the membrane system to be designed and operated at higher fluxes. Alternatively, the reduced volume of discharged water will allow membrane systems to be operated at higher system recovery without impacting on the filtration cycle time and membrane performance.

In another aspect, the invention relates to a batch membrane filtration process having a permeate down step prior to backwash or tank drain steps. The process begins by filling the tank and then permeating while adding feed to preserve a generally constant water level above the membranes in the tank. After this step, the water level in the membrane tank is lowered to a reduced level in the permeate down step which involves reducing or stopping feed to the membrane tank but continuing permeation to lower the water level in the membrane tank. The level can be lowered even to the point where a portion of the membranes are exposed to air. The membrane system is then backwashed to dislodge solids from within the membrane pores and from the membrane surface. Optionally, the reduced level in the membrane tank may be such that backpulsing will completely re-immerse the membrane fibers or such that a portion of the membranes remains exposed to air. After the backwash, the membrane tank may be drained. Alternately, a second permeate down step may be used to lower the water level again before draining the tank. The membranes may be backwashed before or after the water level have been lowered. With or without the second permeate down step, a portion of the membranes may be exposed to air when the tank drain starts. The membrane fibers may also be air scoured during one or more of the permeate down step or steps, the backwashing step, the tank drain step or before or between any of these steps. Some of the steps may also overlap with other steps.

In another aspect, the invention relates to a batch membrane filtration apparatus having an overflow area. The overflow area is adapted to receive water from a membrane tank when the water level in the tank is above a normal permeating water level or when the membranes are being backwashed. A valve near the bottom of the overflow area allows water to flow between the overflow area and the membrane tank when desired. In a batch process using the apparatus, permeating on a fresh batch of feed proceeds at a normal permeating water level. At the end of a permeation step, the membranes are backwashed causing water to flow into the overflow area. With the valve near the bottom of the overflow area open, the membranes are returned to permeation until the overflow area has been at least partially emptied, for example to the level of the valve. The membrane tank is then drained and refilled. A plurality of membrane tanks may be served by a single overflow area sized to accommodate the backwash volume of one membrane tank. In this case, the membranes are backwashed in sequence such that no two membrane tanks are backwashed or deconcentrated at the same time and the overflow area can be sized to accommodate one membrane tank.

Other aspects of the invention are described in the claims to the extent that the claims may differ from the summary above.

### BRIEF DESCRIPTION OF THE DRAWINGS

Embodiments of the invention will now be described with reference to the following figures.

FIG. 1 is a schematic diagram of an apparatus suitable for use with the process of FIG. 1.

FIGS. 2, 3, and 4 are representations of various membrane cassettes.

FIG. 5 is a flow diagram of a process according to an embodiment of the invention.

FIGS. 6 and 7 shown side and plan views of another apparatus.

### DETAILED DESCRIPTION OF EMBODIMENTS

### Filtration Apparatus

The following description of a filtration apparatus applies generally to the embodiments which are described further below unless inconsistent with the description of any particular embodiment.

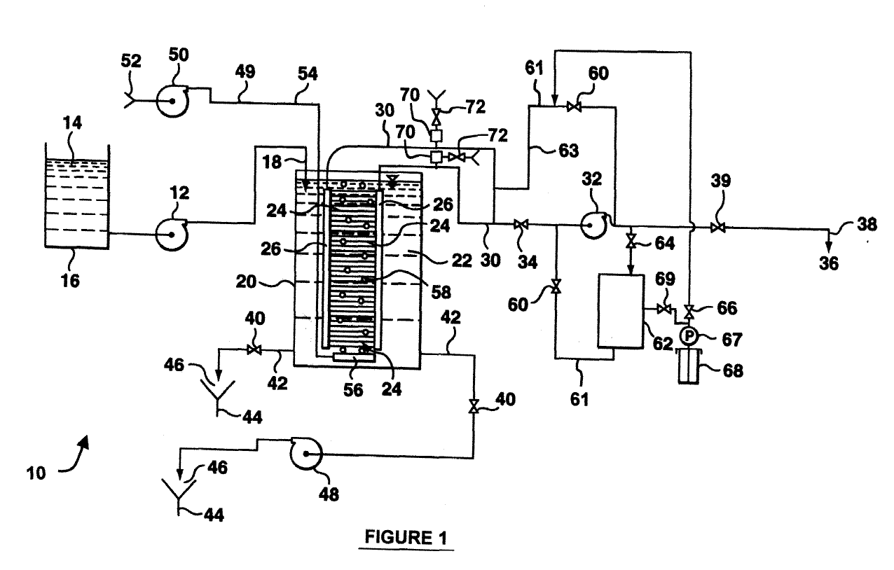

Referring now to FIGS. 1 to 4, a reactor 10 is shown for treating a liquid feed having solids to produce a filtered permeate with a reduced concentration of solids and a retentate with an increased concentration of solids. Such a reactor 10 has many potential applications, but will be described below as used for creating potable water from a supply of water such as a lake, well, or reservoir. Such a water supply typically contains colloids, suspended solids, bacteria and other particles or substances which must be filtered out and will be collectively referred to as solids whether solid or not.

The first reactor 10 includes a feed pump 12 which pumps feed water 14 to be treated from a water supply 16 through an inlet 18 to a tank 20 where it becomes tank water 22. Alternatively, a gravity feed may be used with feed pump 12 replaced by a feed valve. Each membrane 24 has a permeate side 25 which does not contact the tank water 22 and a retentate side which does contact the tank water 22. The membranes 24 may be hollow fibre membranes 24 for which the outer surface of the membranes 24 is the retentate side and the lumens of the membranes 24 are the permeate side 25.

Each membrane 24 is attached to one or more headers 26 such that the membranes 24 are surrounded by potting resin to produce a watertight connection between the outside of the membranes 24 and the headers 26 while keeping the permeate side 25 of the membranes 24 in fluid communication with a permeate channel in at least one header 26. Membranes 24 and headers 26 together form an element 8. The permeate channels of the headers 26 are connected to a permeate collector 30 and a permeate pump 32 through a permeate valve 34. Air entrained in the flow of permeate through the permeate collectors 30 becomes trapped in air collectors 70, typically located at at least a local high point in a permeate collector 30. The air collectors 70 are periodically emptied of air through air collector valves 72 which may, for example, be opened to vent air to the atmosphere when the membranes 24 are backwashed. Filtered permeate 36 is produced for use at a permeate outlet 38 through an outlet valve 39. Periodically, a storage tank valve 64 is opened to admit permeate 36 to a storage tank 62. The filtered permeate 36 may require post treatment before being used as drinking water, but should have acceptable levels of colloids and other suspended solids.

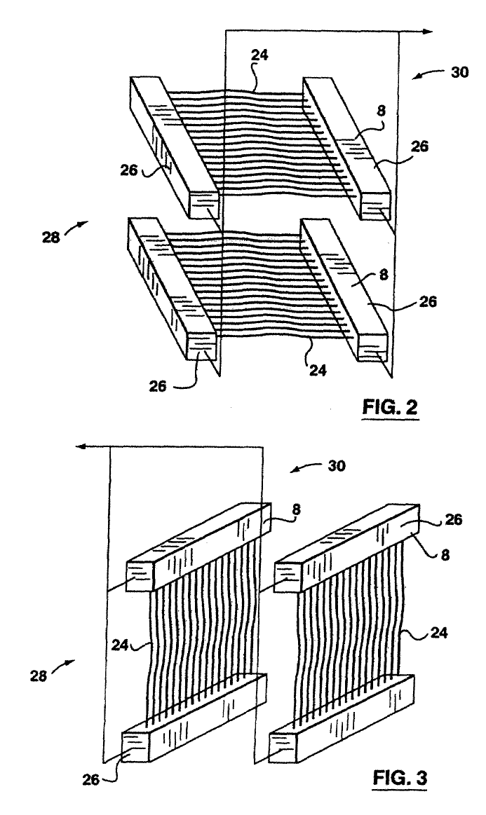

In a large reactor 10, a plurality of elements 8 are assembled together into cassettes 28. Examples of such cassettes 28 are shown in FIGS. 2, 3 and 4 although a cassette 28 would typically have more elements 8 than shown. Each element 8 of the type illustrated may have a bunch between 2 cm and 10 cm wide of hollow fibre membranes 24. Other sorts of elements 8 and cassettes 28 may also be used. The membranes 24 may have an average pore size in the microfiltration or ultrafiltration range, for example between 0.003 microns and 10 microns or between 0.02 microns and 1 micron.

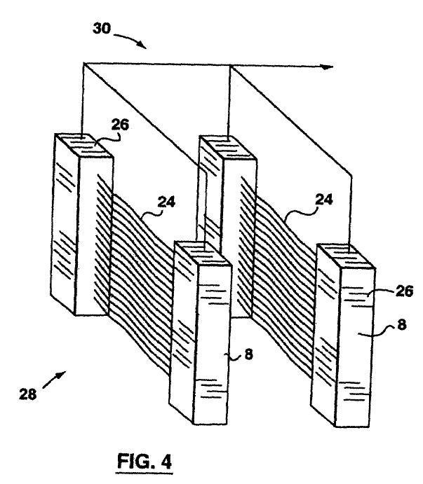

Referring to FIG. 2, for example, a plurality of elements 8 are connected to a common permeate collector 30. Depending on the length of the membranes 24 and the depth of the tank 20, multiple cassettes 28 as shown in FIG. 2 may also be stacked one above the other. Referring to FIGS. 3 and 4, the elements 8 are shown in alternate orientations. In FIG. 3, the membranes 24 are oriented in a horizontal plane and the permeate collector 30 is attached to a plurality of elements 8 stacked one above the other. In FIG. 4, the membranes 24 are oriented horizontally in a vertical plane. Depending on the depth of the headers 26 in FIG. 4, the permeate collector 30 may also be attached to a plurality of these cassettes 28 stacked one above the other. The representations of the cassettes 28 in FIGS. 2, 3, and 4 have been simplified for clarity, actual cassettes 28 typically having elements 8 much closer together and many more elements 8.

Cassettes 28 can be created with elements 8 of different shapes, for example cylindrical, and with bunches of looped fibres attached to a single header or fibers held in a header at one end and loose at the other. Similar modules or cassettes 28 can also be created with tubular membranes in place of the hollow fibre membranes 24. For flat sheet membranes, pairs of membranes are typically attached to headers or casings that create an enclosed surface between the membranes and allow appropriate piping to be connected to the interior of the enclosed surface. Several of these units can be attached together to form a cassette of flat sheet membranes. Commercially available cassettes 28 include those made by ZENON Environmental Inc. and sold under the ZEE WEED trademark, for example, as ZEE WEED 500 or ZEE WEED 1000 products.

Referring again to FIG. 1, tank water 22 which does not flow out of the tank 20 through the permeate outlet 38 flows out of the tank 20 through a drain valve 40 and a retentate outlet 42 to a drain 44 as retentate 46 with the assistance of a retentate pump 48 if necessary.

To provide air scouring, an air supply pump 50 blows ambient air, nitrogen or other suitable gases from an air intake 52 through air distribution pipes 54 to aerator 56 or sparger which disperses scouring bubbles 58. The bubbles 58 rise through the membrane module 28 and discourage solids from depositing on the membranes 24. In addition, where the design of the reactor 10 permits it, the bubbles 58 also create an air lift effect which in turn circulates the local tank water 22.

To provide backwashing, permeate valve 34 and outlet valve 39 are closed and backwash valves 60 are opened. Permeate pump 32 is operated to push filtered permeate 36 from retentate tank 62 through backwash pipes 61 and then in a reverse direction through permeate collectors 30 and the walls of the membranes 24 thus pushing away solids. At the end of the backwash, backwash valves 60 are closed, permeate valve 34 and outlet valve 39 are re-opened and pressure tank valve 64 opened from time to time to re-fill retentate tank 62.

To provide chemical cleaning from time to time, a cleaning chemical such as sodium hypochlorite, sodium hydroxide or citric acid is provided in a chemical tank 68. Permeate valve 34, outlet valve 39 and backwash valves 60 are all closed while a chemical backwash valve 66 is opened. A chemical pump 67 is operated to push the cleaning chemical through a chemical backwash pipe 69 and then in a reverse direction through permeate collectors 30 and the walls of the membranes 24. At the end of the chemical cleaning, chemical pump 67 is turned off and chemical pump 66 is closed. Preferably, the chemical cleaning is followed by a permeate backwash to clear the permeate collectors 30 and membranes 24 of cleaning chemical before permeation resumes.

### Batch Processing

In general, a batch process proceeds as a number of repeated cycles which alternate between generally dead end permeation and a procedure to deconcentrate the tank water 22, the procedure being referred to as a deconcentration. A new cycle usually begins at the end of the preceding deconcentration. Some cycles, however, begin when a new reactor 10 is first put into operation or after chemical cleaning or other maintenance procedures.

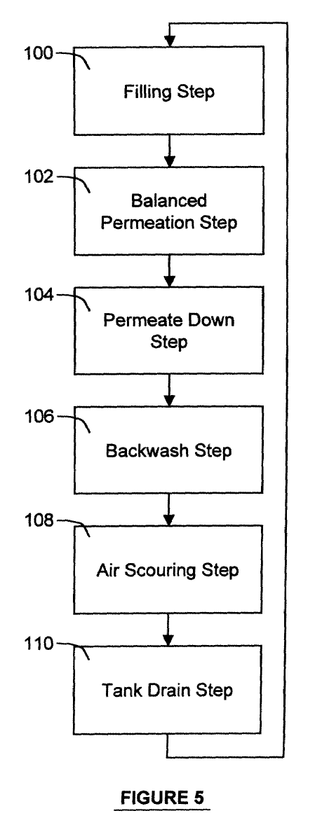

Referring now to FIG. 5, a filtration process for filtering water with immersed membranes has a filling step 100, a balanced permeation step 102, a permeate down step 104, a backwash step 106, an air scouring step 108 and a tank drain step 110. These steps form a cycle which is repeated for continued filtration. Each step will be described in greater detail below.

### Filling Step 100

In the filling step 100, a feed pump 12 pumps feed water 14 from the water supply 16 through the inlet 18 to the tank 20 where it becomes tank water 22. The tank 20 is filled when the level of the tank water 22 completely covers the membranes 24 in the tank 20.

### Balanced Permeation Step 102

During the balanced permeation step 102, drain valves 40 remain closed. The permeate valve 34 and an outlet valve 39 are opened and the permeate pump 32 is turned on. A negative pressure is created on the permeate side 25 of the membranes 24 relative to the tank water 22 surrounding the membranes 24. The resulting transmembrane pressure, typically between 1 kPa and 150 kPa, draws tank water 22 (then referred to as permeate 36) through the membranes 24 while the membranes 24 reject solids which remain in the tank water 22. Thus, filtered permeate 36 is produced for use at the permeate outlet 38. Periodically, a storage tank valve 64 is opened to admit permeate 36 to a storage tank 62 for use in backwashing. As filtered permeate 36 is removed from the tank, the feed pump 12 is operated to keep the tank water 22 at a level which covers the membranes 24. Foam or other substances may be occasionally removed, but there is generally dead end filtration. The balanced permeation step 102 may continue for between 15 minutes and three hours or between 45 minutes and 90 minutes. During the balanced permeation step 102, the membranes 24 may be backwashed or air scoured from time to time prior to the deconcentration phase of the process meaning that balanced permeation continues during or after the air scouring or backwashing.

### Permeate Down Step 104

In the permeate down step 104, the permeate pump 32 continues to run but the feed pump 12 is slowed down or, more typically, stopped. As a result, permeate 36 is produced but the level of the tank water 22 lowers. The tank water 22 may be lowered to the top of the highest part of a membrane 24 or to a point where a portion of the membranes 24 are exposed to air. Depending on the configuration of the membranes 24 or elements 8, exposing a portion of the membranes 24 to air may mean that the level of tank water 22 is below some entire membranes 24 or elements 8 but above others, or that the level of the tank water 22 is below a part of one or more membranes 24 or elements 8 but above other parts of the same membranes 24 or elements 8. The exposed portion of the membranes 24 may also be all of the membranes 24.

Reducing the level in the tanks 20 will temporarily reduce the maximum operating transmembrane pressure and therefore in some cases may cause a temporary reduction in flow. However, the benefit of the reduced filtration cycle time outweighs this temporary reduction in flow. Permeating while a portion of the membranes 24 are exposed to air also draws some air into the permeate 36. This air is collected in the air collectors 70 and periodically discharged and, with sufficiently large air collectors 70, does not interfere with other aspects of the apparatus or process. However, to avoid drawing extremely large amounts of air into the permeate collectors 70, the transmembrane pressure during the permeate down step 104 is kept below the bubble point of the membranes 24 without defects. The amount of air collecting in the air collectors 70 during the permeate down step 104 is monitored. If the amount of air collected over time exceeds a reasonable amount based on diffusion through wet pores, then a defect in the membranes 24 is indicated and they are tested and serviced if necessary.

To end the permeate down step 104, the permeate pump 32 and feed pumps 12 are turned off and the permeate valve 34 and outlet valves 39 are closed.

### Backwash Step 106

In the backwash step 106, with drain valves 40 closed if not also draining the tank 20, backwash valves 60 and storage tank valve 64 are opened. Permeate pump 32 is turned on to push filtered permeate 36 from storage tank 62 through a backwash pipe 63 to the headers 26 and through the walls of the membranes 24 in a reverse direction thus pushing away some of the solids attached to the membranes 24. The volume of water pumped through the walls of a set of the membranes 24 in the backwash may be between 10% and 40%, more often between 20% and 30%, of the volume of the tank 20 holding the membranes 24. At the end of the backwash, backwash valves 60 are closed. As an alternative to using the permeate pump 32 to drive the backwash, a separate pump can also be provided in the backwash line 63 which may then by-pass the permeate pump 32. By either means, the backwashing continues for between 15 seconds and one minute after which time the backwash step 106 is over. Permeate pump 32 is then turned off and backwash valves 60 closed.

The flux during backwashing may be 1 to 3 times the permeate flux and causes the level of the tank water 22 to rise. The reduction in water level during the permeate down step 104 and the increase in water level 104 may be made such that the membranes 24 are fully immersed by the end of the backwash step 106. For example, the membranes 24 may be fully immersed for a subsequent aeration step 108. Alternately, the reduction in water level in the permeate down step 104 may exceed the increase in water level in backwash step 106 such that a portion of the membranes 24 remain exposed to air at the end of the backwash step 106. This decreases the volume of water discharged and time used during the tank drain step 110. However, the aeration step 108 is made less effective and so the aeration step may be moved to, or another aeration step 108 added, after or during the end of the balanced permeation step 102, between the balanced permeation step 102 and the permeate down step 104 or during the start of the permeate down step to include a time while the membranes 24 are fully immersed.

### Air Scouring Step 108

Scouring air is provided by turning on the air supply pump 50 which blows air, nitrogen or other appropriate gas from the air intake 52 through air distribution pipes 54 to the aerators 56 located below, between or integral with the membrane elements 8 or cassettes 28 and disperse air bubbles 58 into the tank water 22 which flow upwards past the membranes 24.

The amount of air scouring to provide is dependant on numerous factors but is preferably related to the superficial velocity of air flow through the aerators 56. The superficial velocity of air flow is defined as the rate of air flow to the aerators 56 at standard conditions (1 atmosphere and 25 degrees celsius) divided by the cross sectional area effectively scoured by the aerators 56.

In the air scouring step 108, scouring air is provided by operating the air supply pump 50 to produce air corresponding to a superficial velocity of air flow between 0.005 m/s and 0.15 m/s for up to two minutes. This extended period of intense air scouring scrubs the membranes 24 to dislodge solids from them and disperses the dislodged solids into the tank water 22 generally. At the end of the air scouring step 104, the air supply pump 50 is turned off. Although shown after the backwash step 106, the air scouring step may also be provided before, during or between any of steps 104 to 110. Although the air scouring step 108 is most effective while the membranes 24 are completely immersed in tank water 22, it is still useful while a portion of the membranes 24 are exposed to air. The air scouring step 108 may also be more effective when combined with backwashing. For example, the air scouring step 108 may start at generally the same time as the backwash step 106 and stop when, or after, the backwash step 106 stops. In this way, air scouring occurs while backwashing when air scouring is most effective for a given water level.

For feed water 14 having minimal fouling properties, air scouring as part of the deconcentration step is all that is required. For some feed waters having more significant fouling properties, however, gentle air scouring is also provided during the permeation step 102 to disperse the solids in the tank water 22 near the membranes 24. This gentle air scouring is to prevent the tank water 22 adjacent the membranes 24 from becoming overly rich in solids as permeate is withdrawn through the membranes 24. Accordingly, such air scouring is not considered part of the air scouring step 104. For gentle air scouring, air may be provided continuously at a superficial velocity of air flow between 0.0005 m/s and 0.015 m/s or intermittently at a superficial velocity of air flow between 0.005 m/s and 0.15 m/s.

### Draining Step 110

In the draining step 110, the drain valves 40 are opened to allow tank water 22, then containing an increased concentration of solids and called retentate 46, to flow from the tank 20 to through a retentate outlet 42 to a drain 44. The retentate pump 48 may be turned on to drain the tank more quickly, but in many installations the tank will empty rapidly enough by gravity alone. The draining step 110 can also be started while any of steps 104, 106 or 108 is ongoing or while a portion of the membranes 24 is exposed to air. In most industrial or municipal installations it typically takes between two and ten minutes and more frequently between two and five minutes to drain the tank 20 completely from full and less time when the water level has already been reduced.

### Alternate Processes

In alternate embodiments, some of the steps described above are performed in different orders or more than once. For example, after the permeate down step 104, the tank drain step 110 may be performed before the backwash step 106. A second tank drain step 110 may then be added after the backwash step 106 or the drain valves 40 may be left open so that the tank drain step 110 continues during the backwash step 106. The backwash step 106 and tank drain step 110 may also occur generally or partially at the same time. In these methods, total time required for the tank drain step 110 may be reduced although the aeration step 108 may need to be relocated, supplemented or made longer.

In another alternate embodiment, after the backwash step 106, a second permeate down step 104 may be performed before the tank drain step 110. This further reduces the volume of water discharged during the tank drain step. The second permeate down step 104 may continue for part or all of the tank drain step 110. If the second permeate down step 104 is continued until the tank is empty, monitoring the rate of air collection in the air collectors 70 provides a test of the integrity of all of the membranes 24.

In another alternate embodiment, the order of the permeate down step 104 and backwash step 106 are reduced. Thus, after the balanced permeation step 102, the water level is increased with a backwash step 106. This requires a tank 20 with increased freeboard, but also increases the available TMP for the permeate down step 104. The tank water 22 is also diluted of solids by the backwash step 106 which may reduce fouling of the membranes 24 during the permeate down step 104. The air scouring step 108 can also be performed during the backwash step 106 with the membranes 24 fully immersed in tank water for the entire backwash step 106. This may provide for a very effective air scouring step 108.

In another alternate embodiment, the tank drain step 110 is performed after the permeate down step 104. The backwash step 106 is performed after the tank drain step 110 and becomes part of the filling step 100 of the next batch. By this embodiment, solids pushed off of the membranes 24 during the backwash step 106 do not leave the tank until the tank drain step 110 of the next cycle. However, the volume of water discharged is made very small for a given length of the permeate down step 104. The air scouring step 108 is performed before or during the permeate down step 104, during the backwash step 106 or before or after the balanced permeate step 102.

### Further Alternate Apparatus and Process

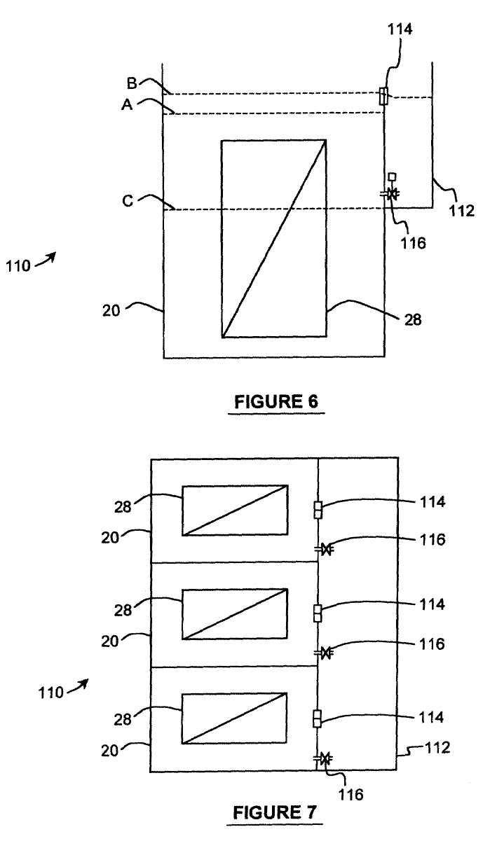

FIGS. 6 and 7 show a second reactor 110. The second reactor 110 differs from the reactor 10 in having an overflow area 112 in communication with each of three tanks 20 through an opening 114 which may be a pipe, a gate or an overflow area, such as a weir, and a return valve 116 operable to open and close an opening or pipe between the overflow area 112 and each tank 20. The openings 114 are located above a normal permeating level A and allow water to flow from a tank 20 to the overflow area 112 when the water level is at an increased level B in that tank 20. The return valves 116, when open, allow water to return from the overflow area 112 to the membrane tanks 20. Although three membrane tanks 20 are shown, there could be other numbers, for example between 1 and 10, connected to a single overflow area 112. Each tank 20 has all of the elements shown for the reactor 10 of FIG. 1 associated with it, although these items are not shown to simplify the illustration. Each tank 20 may be deconcentrated separately from the other tanks or all tanks 20 may be deconcentrated at the same time if the overflow area 112 is made larger than illustrated as required.

Each tank goes through a filtration process cycle. However, the timing of these cycles may be staggered between tanks 20 so that only one tank 20 requires use of the overflow area 112 at a time. In this way, the overflow area 112 can be sized for one tank 20 rather than for all tanks 20 in the second reactor 110.

The process for each tank 20 starts with a filling step 100 as described above. This is followed by a balanced permeation step 102 with the water level above the cassettes 28 but below the overflow 114, for example at line A shown. Return valve 116 is closed. After balanced permeation, a backwash step 106 is performed. This causes water from the tank 20 to rise, for example to level B, and to overflow into the overflow area 112. Return valve 116 may be open or closed during this step. If return valve 116 is kept open during this step, overflow 114 may be omitted or replaced with a wall extending above level B. After backwash step 106, a permeate down step 104 is performed. Return valve 116 is open during this step to allow water in the overflow area 112 to return to the tank 20. The permeate down step 104 may continue until a desired water level in the tank 20 is achieved, for example level C or another level below water return valve 116, although a level above return valve 116 may also be chosen. A draining step 110 is then performed, followed by a return to the filling step 100 of the next cycle, the filling performed with either feed water or a second backwashing. Return valve 116 is closed before filling step 100. An air scouring step 108 may also be provided at one or more times before or during the process, for example during the backwash step 106. This process provides advantages in that a volume of water less than the volume of the tank 20 is discharged during the draining step 110, that an air scouring step 108 may be performed with the cassettes 28 fully immersed and being backwashed, and that a portion of most of the permeate down step 104 may be performed with the water in the tank 20 diluted with backwashed permeate. This dilution counters the fact that the permeate down step 104 is performed after the backwash step 106 and in the presence of solids released during backwashing.

It is to be understood that what has been described are exemplary embodiments of the invention. The invention nonetheless is susceptible to changes and alternative embodiments without departing from the subject invention, the scope of which is defined in the following claims.

We claim:

1. A batch membrane filtration process comprising the steps, performed in repeated cycles, of:
a) filling a tank to immerse membranes in the tank;
b) after step (a), withdrawing permeate through the membranes while adding feed to keep the membranes immersed;
c) after step (b), withdrawing permeate while the flow of feed is reduced or stopped to lower the water level in the tank;
d) backwashing the membranes; and,
e) after step (c), draining the tank.

2. The process of claim 1 wherein step (d) occurs after step (c) and before step (e).

3. The process of claim 1 wherein, in step (c), the water level in the tank is lowered to a point where a portion of the membranes are exposed to air.

4. The process of claim 3 wherein the volume of water provided during step (d) re-immerses the portion of the membranes exposed to air.

5. The process of claim 4 wherein the membranes are scoured with air as or after the portion of the membranes is re-immersed.

6. The process of claim 2 wherein step (c) is repeated after step (d) and before step (e).

7. The process of claim 1 wherein step (d) occurs after step (e).

8. The process of claim 7 wherein, after step (d), step (e) is repeated before returning to step (a).

9. The process of claim 8 wherein step (c) is repeated after step (d) and before step (e) is repeated.

10. The process of claim 1 wherein the membranes are scoured with air before, during or between any of steps (c), (d) or (e).

11. The process of claim 1 wherein step (d) is performed before step (c).

12. A batch membrane filtration process wherein the tank is drained starting at a time when the water level has been lowered by permeation to expose a portion of the membranes to air.

13. A reactor having a membrane tank with a membrane module and an overflow area, the overflow area being fluidly connected to the tank through a valved passageway from the bottom of the overflow area to the tank such that the overflow area can drain into the tank, the valved passageway located below the top of the membrane module.

14. The reactor of claim 13 having an opening between the tank and the overflow area, the opening located above the valved passageway and above the top of the membrane module.
